(19) United States
(12) Patent Application Publication
(10) Pub. No.: US 2005/0132589 A1
(43) Pub. Date: Jun. 23, 2005

(54) Visual alignment aid for handheld tools

(76) Inventor: Robert Frederick Johnson, Bellevue, WA (US)

Correspondence Address: Anthony Claiborne, 849 136th Ave. N.E., Bellevue, WA, 98005, US

(21) Appl. No.: 11/018,276

(22) Filed: Dec. 21, 2004

Related U.S. Application Data
(60) Provisional application No. 60/531,162, filed on Dec. 22, 2003.

(51) Int. Cl. G01C 15/00

(52) U.S. Cl. 33/286

(57) ABSTRACT

An apparatus, attaching to or integral to a hand tool, locates a collimated optical source or sources offset and at an angle from the axis of action of the tool, projecting a beam forming an alignment pattern onto a work surface. When the tool is held in the preferred perpendicular orientation to the work surface, the beam strikes the surface at a nominal distance from the tool point. If the tool is not held at the proper angle, the distance between the alignment pattern and the tool point will change by a large amount. To provide reference to make this distance change even more pronounced, a second beam may be added which is oriented parallel to the axis of action of the tool, projecting a reference pattern onto the work surface. The relationship between the reference pattern and the tool point will not appreciably change as the tool orientation changes. The apparatus is suitable for aligning both rotary and non-rotary hand tools.

### CROSS-REFERENCE TO RELATED APPLICATION

This application claims priority from U.S. provisional application No. 60/531,162, filed Dec. 22, 2003, entitled VISUAL ALIGNMENT AID FOR HANDHELD TOOLS.

### BACKGROUND OF THE INVENTION

1. Field of the Invention

This invention relates to an alignment aid that generates visual cues for an operator to hold a tool in a perpendicular orientation to a work surface. It is adaptable to provide alignment for a variety of tools, including both those tools which operate by rotating axial movement, such as drills, routers and the like, as well as those tools with member driving apparatus such as nail guns, rivet guns and the like.

2. Description of the Related Art

The prior art means to hold a tool perpendicular to a work surface include an integrated bubble level on the tool, an operator held square, and guide bushings. A bubble level can be used if the axis of the tool is perfectly horizontal or vertical. A bubble level cannot be used at any other orientation. Another method is to use a small square held against the tool and on top of the work surface. A square only accurately gives alignment information in one axis. It also requires the operator to hold the square while using the tool which often results in an unsafe practice. Furthermore, the degree to which the operator can gauge the error between the square and the irregularly shaped profile of the tool is imprecise. In the case of drilling, a guide bushing mounted in a plate provides another method to hold the tool perpendicular to the work surface. While this works well, a different diameter guide bushing must be used for every diameter of drill bit. This requires the operator to have all anticipated sizes of bushings on hand and places to store them. Bushings and plates are heavy and take up storage space.

What is needed is an alignment apparatus which reliably tells the operator the degree of alignment error of the tool in two axes, can be used regardless of the orientation of the axis of the tool, requires no external holding or other aids, and has a large sensitivity to alignment errors.

### BRIEF DESCRIPTION OF THE INVENTION

Many tools with a single point of contact with the work surface require perpendicular orientation to the work surface for normal use. These tools include rotary tools such as drills as well as non-rotating tools like rivet guns and nail guns. The present invention provides a new method for visualizing perpendicular alignment between a handheld tool with a single point of contact and the work surface. The method for a nonrotary tool involves displaying a collimated optical source(s) on at least two adjacent sides of the tool at an angle from the axis of action of the tool. If the tool is not held at the proper angle, the distance between where the alignment beam(s) impinges on the work surface and the tool point will change by a large amount. This change will either get closer to the tool point or farther away depending on the orientation and magnitude of the error. When the tool is held in the preferred perpendicular orientation to the work surface, the alignment beam(s) strikes the work surface at an equal distance on all sides of the tool. When the tool is out of alignment, the distance between where the alignment beam strikes the surface and the point where the tool contacts the surface will be uneven. To make this difference in distance even more pronounced, a second light source may be added as a reference beam, oriented parallel to the axis of action of the tool. The point between where the reference beam(s) impinges on the work surface and the tool point will not appreciably change as the tool orientation changes. For a rotary tool, the invention requires only one collimated source—the rotary action of the tool creates a circular scanned pattern that reveals alignment errors.

### BRIEF DESCRIPTION OF THE DRAWINGS

Other objects, advantages, features and characteristics of the present invention, as well as methods, operation and function of related elements of structure, and the combination of parts and economies of deployment, will become apparent upon consideration of the following description and claims with reference to the accompanying drawings, all of which form a part of this specification, wherein:

FIG. 1 is a cross-section view of an embodiment of the invention;

FIG. 2 is an axial view of an embodiment of the invention;

FIG. 3a illustrates scan patterns visible to an operator of a rotary tool when the tool is in perfect alignment;

FIG. 3b illustrates scan patterns visible to an operator of a rotary tool when the tool is tilted to the right;

FIG. 4 is an electronic circuit diagram for a laser diode circuit employed in an embodiment of the present invention; and

FIG. 5a is a side view of a laser diode and collimating optics employed in an embodiment of the present invention;

FIG. 5a is a top view of a laser diode and collimating optics employed in an embodiment of the present invention;

FIG. 6a is a stripe pattern visible to an operator of a non-rotary tool when the tool is in perfect alignment; and

FIG. 6b is a stripe pattern visible to an operator of a non-rotary tool when the tool is tilted to the right.

### DETAILED DESCRIPTION OF THE PREFERRED EMBODIMENTS

The present invention is an apparatus, attaching to or integral to a hand tool, which locates a collimated optical source or sources offset and at an angle from the axis of action of the tool. This light source will be referred to as the alignment beam. When the tool is held in the preferred perpendicular orientation to the work surface, the alignment beam(s) strikes the surface at a nominal distance from the tool point. If the tool is not held at the proper angle, the distance between where the alignment beam(s) impinges on the work surface and the tool point will change by a large amount. This change will either get closer to the tool point or farther away depending on the orientation and magnitude of the error.

To make this distance change even more pronounced, a second light source(s) may be added which is oriented parallel to the axis of action of the tool. This light source(s) will be referred to as the reference beam(s). The point between where the reference beam(s) impinges on the work surface and the tool point will not appreciably change as the tool orientation changes. The reason is that the angular error between the reference beam and the surface is equal to 1/cosine of the angular error and this does not appreciably change for large orientation errors. Thus, this light pattern acts as a reference datum on the work surface to compare with the light pattern from the alignment beam.

The method applied to a non-rotary tool involves disposing at least four light sources, symmetrically deployed about the axis of action of the tool. All four alignment beams are at the same acute angle with respect to the axis of the tool. In the preferred method, at least four additional reference beams are symmetrically deployed about the tool axis and oriented parallel to the tool axis. To better delineate the light patterns on the work surface, the collimated sources are modified by cylindrical lenses to form light fans. When a light fan strikes a flat surface it forms a thin line.

The method applied to a rotary tool uses a collimated light source that sweeps out a circular pattern of light by utilizing the rotary motion of the tool. The single light source can be mounted onto or integrated into the rotary axis of the tool. When the tool is spun up to speed, the alignment beam and the reference beam appear to be circles. The pattern traced out on the work surface appears to be continuous because of persistence of vision. When the rotary tool is held perpendicular to the surface, two concentric circles are seen. However, if the tool is not perpendicular to the surface, the larger diameter alignment circle becomes elliptically shaped. The reference beam that is parallel to the rotary axis changes very little in shape to that of a circle.

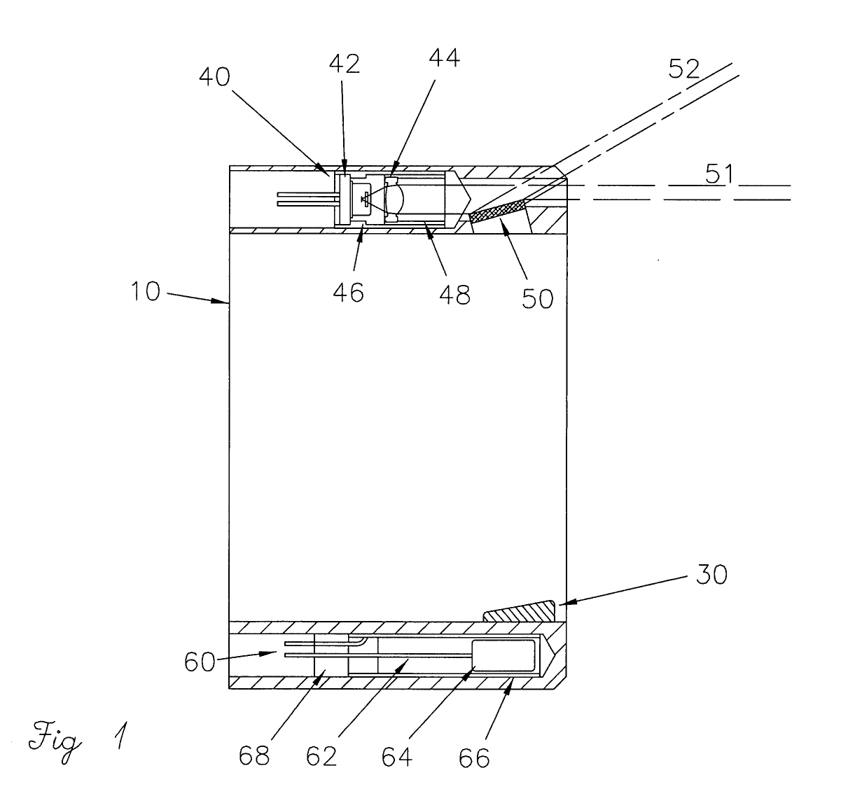

Turning now to FIGS. 1 through 4, a detailed description of one embodiment of the present invention is described, comprising a collar containing the constituent optical and electrical parts that is designed to be attached to the rotating part of a tool.

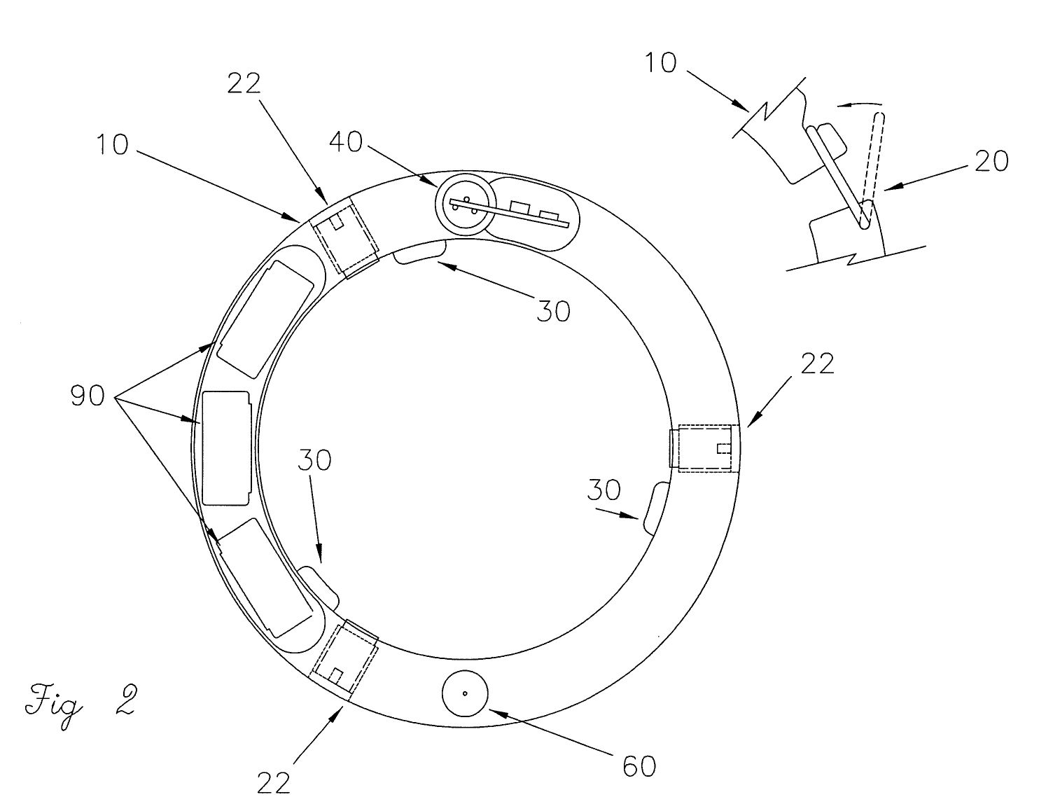

FIGS. 1 and 2 show the cross section and axial views of the invention, respectively. The body of the tool is composed of a collar [10] which can be rigid or made of an extendable plastic such as medium durometer polyurethane. The collar is fashioned to slip over a portion of the tool such as the chuck of a drill and further comprises a means for fixedly retaining the collar on the tool. If the collar is extendable plastic, it can be stretched over the portion of the tool, the retaining means thereby simply being the elastic grip of the extensible collar on the tool. If the collar is rigid, the retaining means may be a latching mechanism such as clasp mechanism [20] or set screws [22]. To accommodate slightly different rotary tool diameters a number of replaceable soft pieces of plastic [30] can be placed on the inside diameter of the invention.

A collimated laser source [40] preferably comprising a visible wavelength laser diode [42], collimating lens [44]; a thin-walled laser diode mount [46] and thin-walled lens tube [48] is mounted parallel to the through-hole of the invention. During subassembly, the laser diode mount [46] is affixed to lens mount [48] after collimation, by means such as by soldering, quick curing epoxy or UV curable epoxy. The collimating lens [44] can either be glass or plastic and gives best performance if it is an aspheric lens with a short focal length—4 mm is a typical value. The useful diameter of lens [44] is typically 4 mm and the resulting collimated beam diameter is typically 3 mm. Lens [44] is attached to lens tube [48], by means such as by epoxy or by swaging.

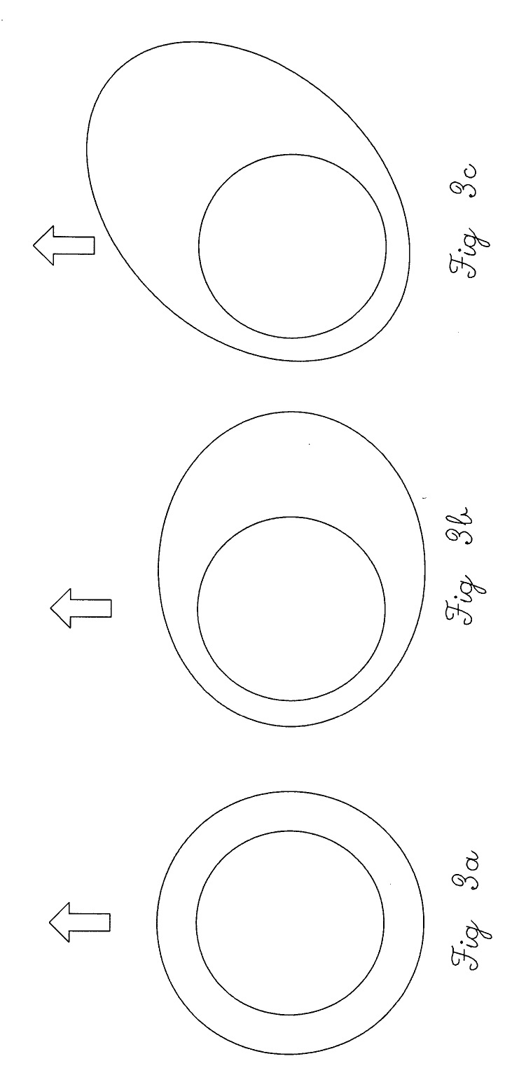

In one embodiment of the present invention, the collimated light from a single laser diode source [40] is split into two beams by a beam splitting mirror [50]. The beam that continues parallel to the axis of rotation serves as the reference beam [51] and the beam that is deflected by beamsplitting mirror [50] serves as the alignment beam [52]. The angle of the alignment beam [52] with respect to the rotary axis of the tool gives good performance if it is between 30 and 45 degrees; though these angles are not restrictive. In this embodiment, mirror [50] is mounted and arranged such that approximately 30% of the power of the laser source is included in the reference beam [51]. Because the alignment beam [52] traces out a larger diameter and scan over more surface at a faster rate, it would appear dimmer if the beams had a 50%/50% power split. FIG. 3 shows three typical scan patterns an operator would see if standing behind a rotary tool. The up direction is denoted with an arrow. In FIG. 3a, the alignment is perfect and two concentric circles are seen. In FIG. 3b, the tool is tilted towards the right. In FIG. 3c, the tool is tilted by an even larger angle but up and to the right.

In one embodiment of the present invention, the collimated light from a single laser diode source [40] is split into two beams by a beam splitting mirror [50]. The beam that continues parallel to the axis of rotation serves as the reference beam [51] and the beam that is deflected by beamsplitting mirror [50] serves as the alignment beam [52]. The angle of the alignment beam [52] with respect to the rotary axis of the tool gives good performance if it is between 30 and 45 degrees; though these angles are not restrictive. In this embodiment, mirror [50] is mounted and arranged such that approximately 30% of the power of the laser source is included in the reference beam [51]. Because the alignment beam [52] traces out a larger diameter and scan over more surface at a faster rate, it would appear dimmer if the beams had a 50%/50% power split. FIG. 3 shows three typical scan patterns an operator would see if standing behind a rotary tool. The up direction is denoted with an arrow. In FIG. 3a, the alignment is perfect and two concentric circles are seen. In FIG. 3b, the tool is tilted towards the right. In FIG. 3c, the tool is tilted by an even larger angle but up and to the right.

In the exemplary embodiment, batteries [90] of approximately 180 mAh energy capacity or greater and 1.5V potential form the power source of this invention. The batteries can be molded in place for a disposable invention or in battery compartments for a non-disposable invention. In this embodiment, the batteries are small diameter, coin cell type of alkaline or silver oxide composition, though other types such as lithium can be used.

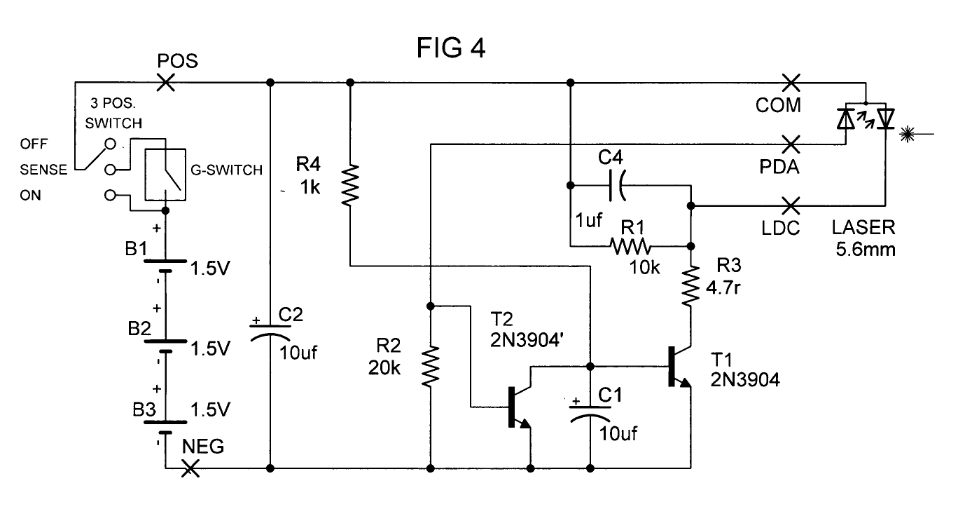

Those skilled in the art of laser drive electronics appreciate there are many ways to drive a laser diode that has a monitor photodiode or does not have a monitor photodiode. A typical electronic circuit which safely operates the laser diode is shown in FIG. 4. This two transistor circuit operates the laser diode in a constant power mode independent of temperature. It can safely operate low power laser diodes from an unregulated voltage between 3 and 6 volts DC. Additionally, to conserve battery power, this circuit can modulate the laser diode in an on/off fashion at several hundred Hertz to save power. The user will see a dashed laser scanned circle/ellipses instead of solid lines, but at the advantage of extending battery life. A three position switch [95] can be placed across the centrifugal switch so that the system functions in three ways; unconditionally ON, unconditionally OFF, or operate when centrifugal switch closes above a certain angular velocity.

In preferred embodiments, in addition to the alignment beam, a second beam or beams from a light source or sources oriented parallel to the axis of action of the tool is used to serve as reference beam(s). In the embodiment described above, the alignment beam and the reference beam(s) are derived by splitting the beam from a single laser diode source. As will be apparent to persons of skill in the art, however, other embodiments may derive alignment beam(s) and reference beam(s) from separate light sources. In any case, the function of the reference beams(s) is to provide a reference shape to contrast with the shape formed by the alignment beam. The point between where the reference beam(s) impinges on the work surface and the tool point will not appreciably change as the tool orientation changes. The reason is that the geometric error between the reference beam and the tool point is equal to 1/cosine of the tool tilt angle and this does not appreciably change for large orientation errors. For example, a 3 three degree error between the surface perpendicular and the tool axis only distorts the reference beam scanned circle by a factor of 1.001—not at all noticeable by the operator.

However, the degree of distortion of the scanned alignment beam ellipse is an indication of the magnitude of the alignment error and is greatly exaggerated by alignment errors. For example, a 45 degree aimed alignment beam will elongate one axis of the scanned circle into an ellipse by a factor 10 times greater than the reference beam for the same 3 degree error. The more distinct cue is the point of closest approach of the two scanned patterns will move closer to each other, further magnifying the alignment error. For example, a 45 degree alignment beam mounted off the rotation axis by 1 inch and 3 inches away from the surface, a 3 degree tilt error results in a 0.315 inch difference between the point of closet approach and farthest approach between the two scanned patterns. This is very easily seen by the operator. The “scale factor” for this geometry is approximately 0.1″ per degree of tool tilt error. Thus this invention highly magnifies any alignment error and presents it graphically to the user. The point of closest approach of the two scanned patterns indicates the misalignment vector—rotating the rotary tool away from the point of closest approach of the two patterns corrects the alignment error. The optimum visual cue for the operator to maintain is two concentric circles. It should be appreciated by those skilled in the art of optical alignment that is it not necessary to have two laser beams—all this is required for this invention is the angled beam—having a reference beam makes gauging the alignment error easier to observe and magnifies errors better than a single alignment beam.

It is appreciated by those skilled in the art that the laser diode mount and lens tube are precision components and made of metal such as brass to offer effective heat removal from the laser diode and to offer temperature stability of the collimated laser source assembly. The laser diode should operate at a wavelength that is highly visible to the human eye. 635 nm is the preferred wavelength though longer wavelengths that are less visible to the eye, such 650 nm or 670 nm, are acceptable. The laser diode should have low threshold current to maximize battery life. The laser diode should have an optical power level between 3 mW and 5 mW though other power levels are acceptable. The laser diode source and the monitor photodiode should protected by a window. Those skilled in the art will appreciate a TO-18 case with a flange diameter of 5.6 mm is such laser source. Larger diameter laser diode sources can be used, such as the 9mm TO-5 case but this will require the collar to have a larger diameter.

Preferably, the laser diode is driven via a constant power feedback electrical circuit to maintain a constant optical power over temperature extremes. The laser can also be driven by a constant current source but there is a risk of destroying the laser diode facets due to high fluence levels when operating a laser diode at a low temperature.

In a 1-G stationary environment, the proof mass will deflect the end of the wire sensing element [62] in simple cantilever bending by an amount equal to:

$$δ = \frac{4 {FL}^{3}}{3 π {YR}^{4}}$$

where δ is the deflection of the proof mass at the end of a wire due to force F, wire radius R, wire length L and modulus of elasticity Y.

For a 0.4mm diameter steel wire 15 mm long with a 1 gram proof mass, the amount of deflection is approximately 0.3 mm. As long as the clearance between the proof mass and the inner wall of the containment tube is greater than this amount the switch will not close under normal gravitational forces. As the collar starts to rotate, a radially outward centrifugal force on the proof mass proportional to the square of the RPMs will cause the circuit to be completed between the mass, the sensing wire and the outer metallic cylinder. For example, if the proof mass is located on a 25 mm radius, then at 240 RPMS a force of 1 G is created. Adding the 1 G gravitational force of the Earth when the proof mass is at the bottom of the rotation cycle, it will see a 2 G force there. When at the top of the cycle it will see a 0 G force because the two G forces cancel. At 3 Gs of centrifugal force, the proof mass will contact the inner wall of the metal containment tube throughout the entire revolution cycle and the circuit will be complete at all times, producing 4 Gs of force at the bottom and 2 Gs at the top.

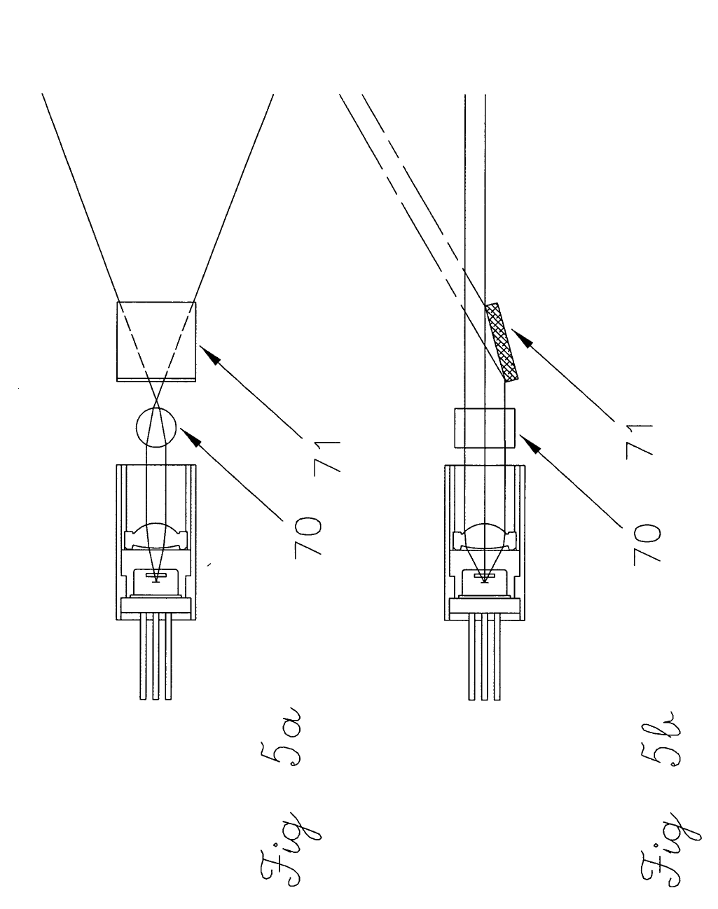

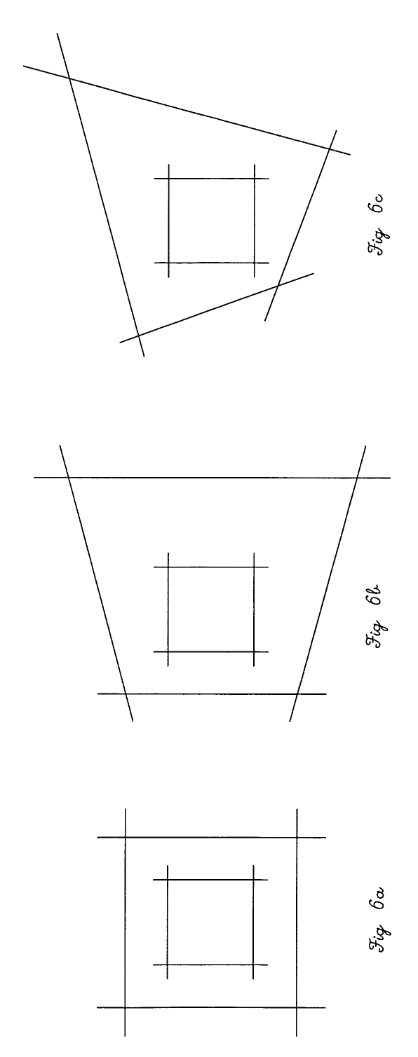

Turning now to exemplary embodiments of the apparatus for use with non-rotating tools, exemplary light sources for use with such tools are shown in FIGS. 5 and 6. FIG. 5a depicts the previously described laser diode and collimating optics, 40, followed by a means of forming an angular fan of light, such as cylindrical lens, 70. FIG. 5a is a side view and FIG. 5b is the top view of the same source. After the collimated light is formed into an angular fan of light, it is further split into two beams by mirror 71. Mirror 71 is fashioned such that the deflected alignment beam has approximately twice the power as does the non-deflected reference beam. The alignment beam is spread out over a longer extent and needs to have more power in it so that it has equally visibility to the light in the reference beam. The cylindrical lens can be a small diameter piece of solid glass or plastic. To those familiar with optical engineering it can be appreciated that both elements, the cylindrical lens and mirror, can be replaced by alternative optical elements, such as a single diffractive optical element.

Exemplary alignment patterns formed by four pairs of reference and alignment light fans for three different tool orientations are shown in FIG. 6. In FIG. 6a is shown the light stripe pattern for a tool held perpendicular to the surface; the ideal situation. FIG. 6b shows the pattern for a tool oriented purely to the right. FIG. 6c shows the light pattern formed when the tool is pointed up and to the right. It can be seen that the ideal pattern for a tool held perpendicular to the work surface is two nested squares with no slanted sides.

### Conclusions, Ramifications and Scope

Accordingly, it can be seen that the invention described herein provides a means of alignment for a variety of tools, including both those tools which operate by rotating axial movement, as well as many non-rotating tools, by providing visual cues that enable an operator to orient a hand tool in a perpendicularly to a work surface.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above. It is intended that the scope of the present invention encompass all means known to those of skill in the art to provide apparatus for visual alignment of hand held tools in accordance with the teachings herein.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

1. An apparatus providing visual alignment aid for an operator of a handheld tool operating on location on a work surface, comprising:
a collimated light source affixed to the tool, projecting an alignment pattern onto the work surface, and
whereby the operator may determine whether the tool is aligned substantially perpendicularly to the work surface by the visual relationship of the alignment pattern to the location of operation on the work surface.

2. An apparatus providing visual alignment aid for an operator of a handheld tool operating on a work surface, comprising:
a first collimated light source affixed to the tool, projecting an alignment pattern onto the work surface, and
a second collimated light source affixed to the tool, projecting a reference pattern onto the work surface
whereby the operator may determine whether the tool is aligned substantially perpendicularly to the work surface by the visual relationship of the alignment pattern to the reference pattern.

3. An apparatus according to claims 1 or 2, wherein the tool is a rotary tool.

4. An apparatus according to claims 1 or 2, wherein the tool is a non-rotary tool.
